(19) United States
(12) Patent Application Publication
(10) Pub. No.: US 2008/0072832 A1
(43) Pub. Date: Mar. 27, 2008

(54) Cat's bathroom buddy

(76) Inventor: Raphael T. Novella, Westmont, NJ (US)

Correspondence Address: SETO PATENTS, 406 RIVERLAND DR., SALEM, VA, 24153, US

(21) Appl. No.: 11/519,632

(22) Filed: Sep. 12, 2006

(51) Int. Cl. A01K 29/00

(52) U.S. Cl. 119/161

(57) ABSTRACT

A device for cleaning clumping kitty litter. The present sifting pitcher is an improvement over traditional kitty litter scoops. The present sifting device has a larger opening and a greater capacity than traditional scoops, thereby making the kitty litter cleaning process quicker and easier. Using the present invention, an entire kitty litter can be cleaned with as few as one or two scoops. As the cleaning process becomes easier, pet owners will more likely clean their kitty litters regularly thus leading to a reduction in the odor associated with kitty litters.

### BACKGROUND OF THE INVENTION

The present invention relates generally to the field of pet accessories and more specifically to an improved device for cleaning kitty litter.

Cats and dogs are popular house pets. While dogs usually go outside the house to “use the bathroom”, many cats go to the bathroom inside the house. Homes with indoor cats include at least one kitty litter. A kitty litter comprises a high-sided pan that contains an amount of sand, or other filler material, that indoor cats use instead of a toilet. In the past, sand and crushed rock primarily made up the filler material and the pet owner waited until the entire kitty litter was full before changing the filler material. Changing the filler material, sometimes referred to as changing the kitty litter, included throwing away all of the old filler material from the pan and replacing the entire contents of the pan with new filler material. Unfortunately, this method of changing the kitty litter also included spending a lot of money on filler material. Further, since the kitty litter was allowed to fill up with excrement, this old method also included having to endure a foul odor, at least in one room of the house. Recently, filler material that absorbs moister and clumps together when made wet has been introduced in the marketplace. This introduction of “clumping” filler material was quickly followed by the introduction of a sifting scoop that allowed owners to scoop the clumps out of their kitty litters without removing the clean filler material. Since the clean filler material was not removed from the pan, pet owners used less filler material during kitty litter changes and the owners subsequently saved money. As the filler material was now being “cleaned” more than being “changed”, the changing process can now be referred to as cleaning of the filler material, or cleaning the kitty litter.

The sifting scoop however, is inadequate for effectively reducing the foul odor that accompanies all kitty litters. To effectively reduce this odor, the filler material must be cleaned regularly. Pet owners are only motivated to regularly clean the kitty litter if the job can be accomplished quickly and easily. Sifting scoops do not offer adequate capacity for holding clumps during the cleaning process. This lack of capacity extends the amount of time the owner must spend during the cleaning of a litter and makes the job harder than it has to be.

What is needed in the field is a sifting device that makes the job of cleaning the kitty litter quicker and easier by being able to gather and hold more clumps than a traditional scoop during the cleaning process. The ideal sifting device would include an easy grip handle and a large opening that facilitates simultaneous collection of multiple clumps.

### SUMMARY OF THE INVENTION

A device that is adapted for cleaning kitty litter pans that use clumping kitty litter. The device has a capacity that is more than twice as much as that of a traditional kitty litter scoop and the device allows a kitty litter pan to be cleaned in substantially less time and with fewer scoops than with the traditional kitty litter scoop. The device comprises a cylindrically shaped container and a handle. The top of the container is open, allowing for easy entry of kitty litter and clumps of kitty litter. The bottom of the container includes multiple small openings that allow clean kitty litter to pass through, but prevents clumps of kitty litter from passing through. The handle is permanently attached the side of the container and allows a user to maneuver and shake the container. The preferred sifting mechanism in the bottom of the container is a screen, however other sifting mechanisms including slits and small holes may also be used.

The open top of the container is preferably greater in size than the bottom of the container, thereby making the process of collecting clumps as easy as possible. The container and handle can be made of plastic or metal and can be provided in many different colors. The exteriors of the container and handle may also be decorated with a picture or a design. The top of the container is preferably beveled so as to aid in the scooping process. Optionally, the sifting device may also include one or more plastic trash bags that are adapted for holding the clumps of kitty litter.

It is an object of the present invention to make the job of cleaning the kitty litter quicker and easier than with traditional scoops.

### BRIEF DESCRIPTION OF THE DRAWINGS

The invention of the present application will now be described in more detail with reference to the accompanying drawings, given only by way of example, in which:

FIG. 1 is a side view of the preferred embodiment;

FIG. 2 is a perspective view of an optional trash bag;

FIG. 3 is a top view of the preferred embodiment;

FIG. 4 is a cross-sectional view of a side of the preferred embodiment; and,

FIG. 5 is a perspective view of an alternative embodiment.

### DETAILED DESCRIPTION OF THE INVENTION

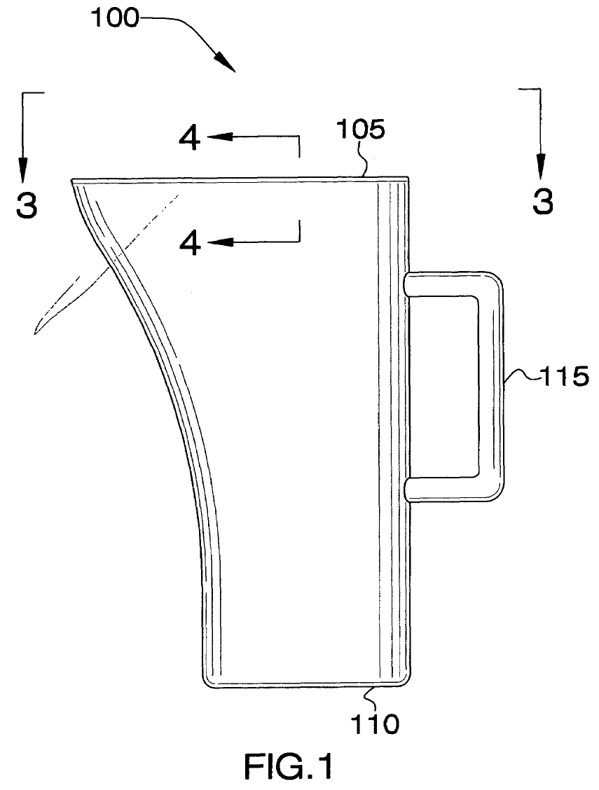

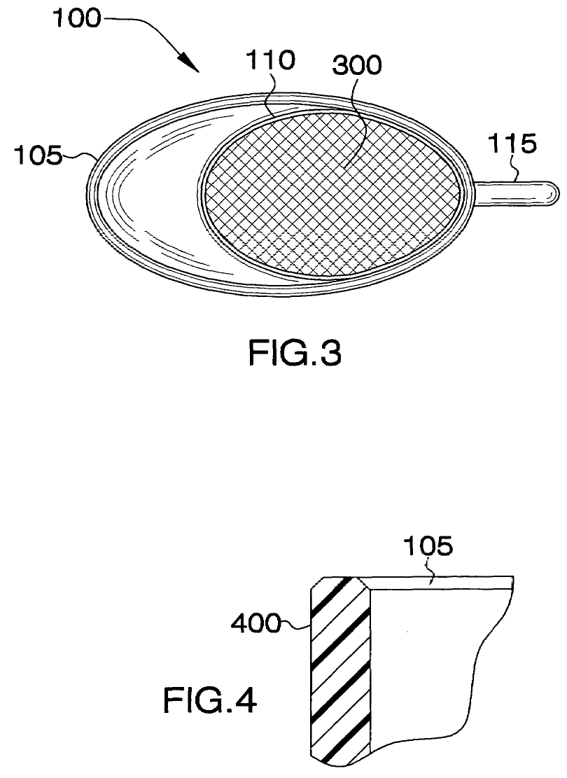

FIG. 1 is a side view of the preferred embodiment 100, which is an improved device for cleaning kitty litters. The preferred embodiment 100 generally has the shape of a pitcher and may be referred to as a sifting pitcher. Like traditional pitchers, the present sifting pitcher 100 has a wide opening at its top 105 and includes a handle 115 on its side for easy handling. The present invention differs from traditional pitchers in that the bottom 110 of the sifting pitcher 100 is porous and is not capable of holding water or any other liquid. Instead, the bottom 110 of the present sifting pitcher 100 comprises a screen (shown in FIG. 3) that advantageously allows clean kitty litter to fall through the bottom 110 of the pitcher. The screen at the bottom 110 of the sifting pitcher does not however, allow clumps of kitty lifter to fall through and retains the clumps in its interior. The large opening at the top 105 of the sifting pitcher allows an entire kitty lifter pan to be cleaned in as little as one or two scoops. Even if the kitty litter has not been cleaned for a day or two, and there are many clumps that need to be removed, the present sifting pitcher 100 makes this traditionally dirty job, a quick and easy job. Since the job of cleaning the kitty litter can now be quick and easy, pet owners will be motivated to clean the kitty litter regularly. Regular cleaning of the kitty litter is the key to reducing, and temporarily eliminating, the foul odor that accompanies dirty kitty litters. The sifting pitcher 100 can be made of plastic or metal and can be provided in different colors or decorated with a design or picture. The arrows with the number 3 next to them indicate the perspective that is shown in FIG. 3. The arrows with the number 4 next to them indicate the perspective that is provided in the FIG. 4.

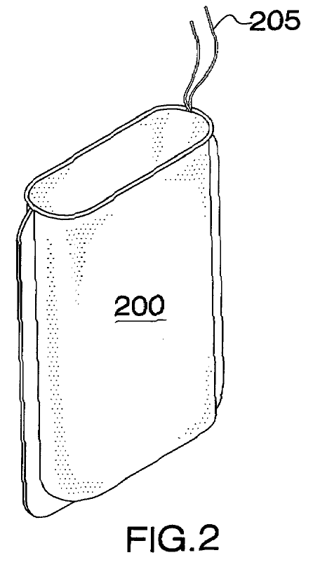

FIG. 2 shows a trash bag 200 that can optionally be provided with the sifting pitcher. The opening of the trash bag 200 has a size that is complementary to the opening at the top of the sifting pitcher. The trash bag 200 is designed so that the top of the trash bag can be placed over and completely cover the top of the sifting pitcher. After the cleaning process is done and the sifting pitcher is full, the pet owner can place the bag 200 over the top of the sifting pitcher and simply turn the pitcher up-side-down to empty to contents into the trash bag. In this way, the pet owner's hands need never come into contact with the contents of the sifting pitcher. Of course, if more than one scoop of the sifting pitcher is required to clean the kitty litter, the pet owner can always pour the contents of the pitcher into the trash bag 200. When all of the clumps from the kitty litter are in the trash bag 200, the pet owner uses the drawstring 205 that is provided within the top of the bag to secure the top of the trash bag 200. The preferred trash bags have a thickness of 3 mils.

FIG. 3 is a top view of the preferred embodiment 100, which shows the large opening provided at the top 105 of the sifting pitcher and the screen 300 that is provided at the bottom 110 of the pitcher. While the top 105 of the pitcher is shown with an oval shape, the tops of other sifting pitchers can take other shapes, including square, in other embodiments. Further, while the handle 115 is shown attached to the right side of the pitcher, the handle may also be placed on other sides of the pitcher in order to increase the amount of litter that can be scooped up in one scooping motion. Finally, while a screen 300 is the preferred sifting mechanism, other sifting mechanisms, such as slits or holes in an otherwise solid bottom, may also be used in other embodiments.

FIG. 4 is a cross-sectional view of the side 400 and top 105 of the preferred sifting pitcher. The top 105 of the preferred embodiment is beveled so as to aid in the scooping ability of the pitcher. The beveled edge at the top 105 of the pitcher presents a smaller leading edge than a flat edge and facilitates entry of clumps into the interior of the sifting pitcher.

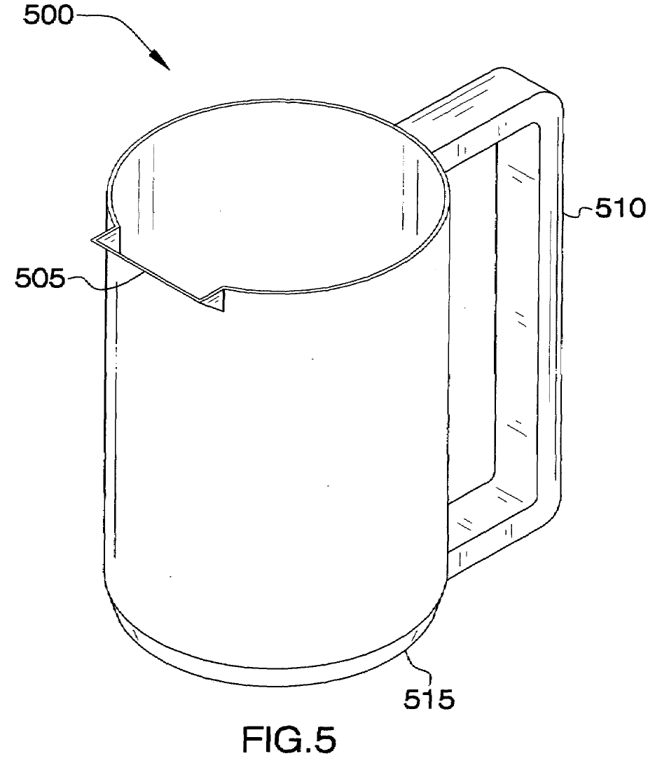

FIG. 5 shows an alternative embodiment 500 of the present bathroom buddy. The alternative embodiment 500 is similar to the preferred embodiment in that it still has the general shape of a pitcher, wherein a handle 510 is provided for lifting and scooping, and the bottom 515 includes a screen for sifting clumps of kitty litter. The alternative embodiment 500 differs from the preferred embodiment by providing a shovel-like scoop 505 on the front of the pitcher. The shovel-like scoop 505 allows more kitty litter to be sifted per scoop. The flat, shovel-like scoop 505 also allows the pitcher to scrape along the flat bottom of the kitty litter pan, thereby insuring all possible clumps are gathered during a scoop.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A device that is adapted for cleaning a kitty litter pan that uses clumping kitty litter, the device having a capacity that is more than twice as much as that of a traditional kitty litter scoop, wherein the device allows the kitty litter pan to be cleaned in substantially less time and with substantially fewer scoops than with the traditional kitty litter scoop, the device comprising:
a container, wherein the container has an open top, a porous bottom and a hollow interior, the open top is adapted to allow entry of the kitty litter into the interior of the container, and the porous bottom includes multiple small openings that allow clean kitty litter to pass through but prevent clumps of kitty litter from passing through; and,
a handle, wherein the handle is permanently attached a side of the container, the handle allowing a user to maneuver and shake the container.

2. The device of claim 1, wherein the porous bottom of the container comprises a screen.

3. The device of claim 1, wherein the multiple small openings in the bottom of the container comprise multiple slits.

4. The device of claim 1, wherein the container has a generally cylindrical shape and a circumference of the top of the container is greater than a circumference of the bottom of the container.

5. The device of claim 1, wherein the container and handle are made of plastic.

6. The device of claim 1, wherein the container and handle are made of metal.

7. The device of claim 1, wherein the device is provided in different colors.

8. The device of claim 1, wherein an exterior of the container includes a decoration, including a picture and a design.

9. The device of claim 1, wherein the top of the container is beveled.

10. The device of claim 1, further comprising at least one plastic trash bag, wherein the trash bag is adapted for holding the clumps of kitty litter.

11. The device of claim 10, wherein the trash bag has a capacity that is greater than the capacity of the container and wherein a top of the trash bag is larger than the top of the container.

12. The device of claim 10, wherein the at least one trash bag has a thickness of 3 mils.

13. The device of claim 1, wherein the open top of the container includes a scoop that facilitates scooping the kitty litter into the container.

14. The device of claim 13, wherein the scoop at the top of the container has a flat, shovel-like leading edge.
